(19) United States
(12) Patent Application Publication
(10) Pub. No.: US 2009/0200207 A1
(43) Pub. Date: Aug. 13, 2009

(54) Absorption Composition and Process for Removing Mercury

(76) Inventors: Stephan Hatscher, Syke (DE); Michael Hesse, Worms (DE)

Correspondence Address: CONNOLLY BOVE LODGE & HUTZ, LLP, P O BOX 2207, WILMINGTON, DE, 19899, US

(21) Appl. No.: 12/305,836

(22) PCT Filed: Jun. 15, 2007
(86) PCT No.: PCT/EP2007/055935

§ 371 Date: Dec. 19, 2008

(30) Foreign Application Priority Data
Jun. 21, 2006 (EP) 06115816.8

(51) Int. Cl. C10G 29/16; B01J 20/08

(52) U.S. Cl. 208/253; 502/415

(57) ABSTRACT

Mercury and/or arsenic or compounds thereof are removed from streams of matter by contacting them with an absorption composition containing silver and aluminium oxide, which absorption composition is characterized in that the aluminium oxide is at least 50% by weight theta-aluminium oxide.

The present invention relates to an absorption composition and a process for removing mercury from streams of substances.

Mercury occurs as impurity in numerous streams of substances. These are often streams which are obtained in the course of processing or burning fossil raw materials or wastes, since fossil raw materials such as petroleum, natural gas or coal or wastes comprises traces of mercury in elemental or usually organically bound form. There are also streams comprising mercury as impurity from processes in which mercury is used, for example the electrolysis hydrogen formed in chlorine production by the amalgam process. Owing to the high toxicity of mercury, it is necessary in most cases to remove mercury from such streams. Mercury can also corrode aluminum workpieces as a result of amalgamation of aluminum with destruction of its surface oxide layer, so that streams which flow through apparatuses or containers made of aluminum have to be virtually mercury-free.

Processes for removing mercury from streams (“demercurization”) are known.

In Fuel Processing Technology 82 (2003) 89-165, J. H. Pavlish et al. give an overview of processes for removing mercury from coal-fired power stations. In Hydrocarbon Processing, 1999 61ff., S. M. Wilhelm gives an overview of processes for removing mercury from liquid hydrocarbon streams.

If metallic mercury is present in liquid form in streams, mercury removal can often be achieved by exploiting the high surface tension or the high specific gravity of mercury and removing it by means of decantation, coalescing filters, activated carbon coated filters or similar mechanical measures. Thus, EP 761 830 A2 discloses a very simple, purely mechanical process in which finely divided mercury in liquids is collected by coalescence in the form of relatively large mercury droplets which can easily be separated off. WO 2004/048 624 A1 teaches a process for removing mercury by filtration on electrographite.

However, mercury has a comparatively high vapor pressure and in some streams such as electrolysis hydrogen or flue gases from combustion furnaces is present predominantly or exclusively in vapor form, so that it can seldom be removed completely by simple mechanical measures. For this reason, processes in which mercury is adsorptively bound are often also used for removing mercury. For example, DE 26 43 478 A1 discloses the use of activated carbon having a specific surface area of at least 250 m²/g for removing mercury from liquids by adsorption.

The formation of solid amalgams is often also utilized for the removal of mercury. The metals which are best suited for this purpose are those of group 11 of the Periodic Table of the Elements, which are usually used in the form of an absorption composition in which the metal is distributed on a support. Thus, DE 21 02 039 discloses a process for removing mercury from gases, in which the gases contaminated with mercury are brought into contact with copper on a porous aluminum oxide support and are thus freed of mercury. U.S. Pat. No. 4,230,486 discloses a process for removing mercury from liquids by passing the liquid over an absorbent comprising metallic silver on a porous support such as activated carbon or ceramic supports. DE 42 21 207 A1 teaches a process for removing mercury from liquids such as alkali metal hydroxide solutions or alkali metal alkoxide solutions by passing the liquid over silver-coated fibers. DE 42 21 205 A1 and DE 42 21 206 disclose processes for working up such fibers after they have been used as intended. DE 41 16 890 discloses a series of absorbents for the removal of mercury which comprise particular metals, especially Cu, Ag, Fe, Bi, but also Au, Sn, Zn or Pd or mixtures of the metals mentioned, in metallic or oxidic form or as sulfide on an activated carbon support having a BET surface area of from 300 to 1000 m²/g.

U.S. Pat. No. 4,911,825 describes the removal of mercury and arsenic from hydrocarbons by means of a catalyst comprising nickel and palladium on aluminum oxide at from 100 to 180° C. in the presence of hydrogen. In a second step, impurities are deposited on copper sulfide. U.S. Pat. No. 4,892,567 discloses a process for separating water and mercury from a stream of hydrocarbons by bringing the stream into contact with zeolites of the types A, 3A, 4A, 5A, which have previously had from 0.01 to 15% by weight of elemental silver or gold applied to them. U.S. Pat. No. 4,909,926 teaches metallic silver on aluminum oxide or copper sulfide on a silicon dioxide/aluminum oxide support for the removal of mercury at from 205 to 315° C. FR 2 310 795 describes the use of metallic gold, silver, copper or nickel on a support comprising silicon dioxide, aluminum oxide or an aluminosilicate having a BET surface area of from 40 to 250 m²/g. WO 91/15 559 discloses a mercury adsorbent which is produced by mixing a pulverulent oxide of a metal of group 3 or 8 to 11 with a high porous support material such as aluminum oxide, silicon dioxide, zeolites or clays and subsequently reducing the mixture. JP 97/105 851 A describes the removal of mercury from liquid propylene over a silver-comprising zeolite.

Ullmann's Encyclopedia of Industrial Chemistry, volume 8, 6th Edition, Wiley-VCH, Weinheim 2003 (ISBN3-527-30385-5), points out, under the keyword “Chlorine” under “4. Chlor-Alkali Process” and “5.3.5. Mercury Emissions”, that mercury can be removed from electrolysis hydrogen by reaction with chlorine to form calomel and deposition of the latter on rock salt by adsorption on activated carbon treated with sulfur or sulfuric acid. However, according to this, the highest purity of the electrolysis hydrogen is achieved by adsorption of mercury on copper on aluminum oxide or on silver on zinc oxide. U.S. Pat. No. 5,053,209 teaches a process for demercurization by bringing into contact with metallic silver on a support such as activated carbon, aluminum oxide, silicon dioxide, aluminosilicate or zeolites, in particular gamma-aluminum oxide,

Ullmann's Encyclopedia of Industrial Chemistry, volume 2, 6th Edition, Wiley-VCH, Weinheim 2003 (ISBN3-527-30385-5), gives, under the keyword “Aluminium Oxide”, an overview of the various aluminum oxides and methods of preparing them. In particular, section 1.5 “Thermal Decomposition of Aluminium Hydroxides” gives an overview of the preparation of the individual aluminum oxide phases by thermal treatment (“calcination” of appropriate aluminum hydroxide or oxide hydrate raw materials).

The steadily increasing demands placed on the purity of streams of substances, in particular their freedom from mercury, make effective processes and absorption compositions for the removal of mercury and other troublesome impurities such as arsenic and arsenic-comprising compounds necessary. It was therefore an object of the present invention to discover an improved absorption composition and an improved process for removing mercury and other troublesome impurities from streams of substances.

We have accordingly found an absorption composition comprising silver and aluminum oxide, wherein at least 50% by weight of the aluminum oxide is theta-aluminum oxide. Furthermore, we have found a process for removing impurities from streams of substances by bringing the stream into contact with an absorption composition, wherein the absorption composition of the invention is used.

A great advantage of the absorption composition of the invention is that the reduction of the silver which is obtained as silver oxide in customary deposition processes to metallic silver, which is necessary in the case of known absorption compositions comprising silver on other supports, can be dispensed with. The absorption composition of the invention can be used in unreduced form for demercurization. This considerably simplifies production and handling of the absorption composition of the invention, in particular because protective measures to prevent oxidation during transport of a catalyst reduced by the manufacturer or facilities for reduction at the point of use become unnecessary.

The absorption composition comprises silver. It comprises silver as metallic silver, as silver oxide or as a mixture of the two. In general, the proportion of silver oxide, calculated as Ag₂O, is at least 50% by weight, preferably at least 60% by weight, particularly preferably at least 70% by weight and very particularly preferably at least 80% by weight, of the total amount of silver and silver oxide. For example, at least 90% by weight of the silver is present as silver oxide or the silver is present essentially completely as silver oxide, i.e. except for the amount of metallic silver which is typically or even unavoidably obtained in the deposition of silver, the silver is present as silver oxide. The silver oxide is preferably Ag₂O. The absorption composition of the invention generally comprises silver in an amount corresponding to at least 0.01% by weight, preferably at least 0.1% by weight and particularly preferably at least 0.5% by weight, and generally not more than 30% by weight, preferably not more than 20% by weight and particularly preferably not more than 10% by weight, of silver oxide Ag₂O, based on the total weight of the absorption composition.

The absorption composition comprises aluminum oxide of which at least 50% by weight is theta-aluminum oxide. The proportion of theta-aluminum oxide preferably makes up at least 60% by weight particularly preferably at least 70% by weight and very particularly preferably at least 80% by weight of the total aluminum oxide comprised in the absorption composition, in each case calculated as Al₂O₃. For example, at least 90% by weight of the aluminum oxide is theta-aluminum oxide, or the aluminum oxide consists essentially of theta-aluminum oxide, i.e. except for amounts of other aluminum oxide phases which are typically or even unavoidably formed in the preparation of theta-aluminum oxide, the aluminum oxide is theta-aluminum oxide. The absorption composition of the invention generally comprises aluminum oxide in an amount of at least 70% by weight, preferably at least 80% by weight and particularly preferably at least 90% by weight, and generally not more than 99.99% by weight, preferably not more than 99.9% by weight and particularly preferably not more than 99.5% by weight, of silver oxide Ag₂O, based on the total weight of the absorption composition.

In the case of materials such as the absorption composition of the invention, the proportion of a virtually unreducible oxide such as aluminum oxide is usually referred to as “support” for the “active composition”, here the silver, in a manner analogous to the terminology used for catalysts.

The absorption composition of the invention can comprise not only silver and aluminum oxide but also all further constituents which are known as constituents of absorption compositions for removing mercury and/or arsenic and arsenic-comprising compounds from streams of substances, For example, it is possible for other inorganic oxides such as oxides of metals of groups 2, 3, 4, 13 and 14 of the Periodic Table of the Elements to be comprised, in particular silicon dioxide, titanium dioxide, zirconium dioxide, zinc oxide, magnesium oxide and calcium oxide, and other metals or metal oxides of Elements of group 11, in particular copper. The maximum amount of such oxides which are different from aluminum oxide and silver and silver oxide present in the support is dependent on the individual case, but is easily determined experimentally in the particular case. In general, the content of such components different from aluminum oxide, silver or silver oxide is not more than 50% by weight, preferably not more than 30% by weight and particularly preferably not more than 10% by weight, based on the total mass of the absorption composition. If such components different from aluminum oxide, silver or silver oxide are comprised in the absorption composition of the invention, the amount of aluminum oxide is to be reduced by the corresponding amount of these components. In other words, in this case, the amounts of components different from aluminum oxide, silver or silver oxide in the absorption composition of the invention and the amount of aluminum oxide add up to the amount indicated above for aluminum oxide.

However, an absorption composition which consists essentially of silver and/or silver oxide and aluminum oxide, i.e. an absorption composition which, except for unavoidable impurities or insignificant amounts, comprises no components other than aluminum oxide, silver or silver oxide, is generally also advantageous. Particular preference is given to an absorption composition which consists essentially (i.e. except for unavoidable impurities, by-products from production or constituents which display no effect in the use according to the invention of the absorption composition) of silver oxide Ag₂O on theta-aluminum oxide.

The BET surface area of the absorption composition of the invention is typically at least 1 m²/g, preferably at least 5 m²/g and particularly preferably at least 10 m²/g, and also not more than 500 m²/g, preferably not more than 400 m²/g and particularly preferably not more than 300 m²/g. For example, the BET surface area is in the range from 30 to 120 m²/g, in the range from 40 to 100 m²/g or in the range from 60-90 m²/g. The usual method of measuring BET surface areas is known; the one-point method using nitrogen based on DIN 66132 is most often employed. The pore volume of the absorption composition of the invention is typically at least 0.1 ml/g, preferably at least 0.15 ml/g and particularly preferably at least 0.2 ml/g, and also not more than 2 ml/g, preferably not more than 1.5 ml/g and particularly preferably not more than 1.2 ml/g. For example, the pore volume is in the range from 0.3 to 1.0 ml/g, in the range from 0.4 to 0.9 ml/g or in the range from 0.5 to 0.8 ml/g. Customary methods of measuring the pore volume are known; the mercury intrusion method based on DIN 66133 is most often employed.

The absorption composition of the invention is produced by the usual method of depositing metal (oxide) on an inorganic support.

Theta-aluminum oxide is a conventional product. To produce it, a suitable aluminum-comprising raw material, preferably boehmite, is peptized by means of a peptizing agent such as water, dilute acid or dilute base. As acid, use is made of, for example, a mineral acid such as nitric acid or an organic acid such as formic acid; as base, use is made of an inorganic base such as ammonia. The acid or base is generally dissolved in water. Preference is given to using water or dilute aqueous nitric acid as peptizing agent. The concentration of the nonaqueous component in the peptizing agent is generally from 0 to 10% by weight, preferably from 0 to 7% by weight and particularly preferably from 0 to 5% by weight Subsequent to peptization, the support is shaped and the shaped bodies are then dried and calcined. Boehmite (alpha-AlO(OH)) is a widespread commercial product but can also be prepared in a known manner by precipitation from a solution of an aluminum salt, for example aluminum nitrate, by means of base, separation, washing, drying and calcination of the precipitated solid immediately before the actual production of the support. Boehmite is advantageously used in the form of a powder. A suitable commercial boehmite powder is, for example, Versal® 250, which is obtainable from Euro Support, Amsterdam. The boehmite is treated with the peptizing agent by moistening it with the peptizing agent and mixing intensively, for example in a kneader, mixer or pan mill. Peptization is continued until the mass can readily be shaped. The mass is subsequently shaped by means of customary methods to give the desired shaped support bodies, for example by ram extrusion, screw extrusion, tableting or agglomeration. Any known method is suitable for shaping, and customary additives can be used if necessary. Examples of such additives are extrusion or tableting aids such as polyglycols or graphite.

It is also possible to mix additives which act as burn-out materials and influence the pore structure of the support after calcination in a known manner, for example polymers, fibers, natural burn-out materials such as ground nut shells or other customary additives, into the raw support composition prior to shaping.

After shaping, the shaped bodies are dried in a customary manner, generally at a temperature above 60° C., preferably above 80° C. and particularly preferably above 100° C., for example at a temperature in the range from 120° C. to 300° C. Drying is continued until water present in the shaped bodies has been given off essentially completely from the shaped bodies, which is generally the case after a few hours. Usual drying times are in the range from one to 30 hours and are dependent on the drying temperature set; higher temperatures shorten the drying time. Drying can be accelerated further by use of reduced pressure.

After drying, the shaped bodies are converted into the finished support by calcination. The calcination temperature is in the range from 900° C. to 1100° C., preferably in the range from 950° C. to 1050° C. and particularly preferably in the range from 980° C. to 1030° C. The calcination time is generally from 0.5 to 5 hours, preferably from one to 4 hours and particularly preferably from 1.5 to 3 hours. Calcination is carried out in a conventional furnace, for example in a rotary tube furnace, in a tunnel kiln or in a muffled furnace. Calcination can follow drying directly without intermediate cooling of the shaped bodies. The BET surface area and the pore volume are set by known methods (in particular use of finer or coarser starting materials, calcination time and calcination temperature).

If desired, other constituents of the absorption composition of the invention can be incorporated into the support during production of the support. The production of supports comprising not only aluminum oxide is known.

After calcination, the silver and if desired further constituents of the absorption composition of the invention are deposited on the support produced in this way.

The silver to be deposited on the support and also further constituents can be applied to the support by any known method, for example by coating from the gas phase (chemical or physical vapor deposition). However, the preferred method is impregnation with a solution of the substances to be deposited and/or compounds which are converted into the substances to be deposited during the course of further processing. The individual substances to be deposited can be deposited individually and/or in partial amounts in a plurality of process steps or together and completely in one process step. Preference is given to joint deposition in one impregnation step. After impregnation or after the individual impregnation steps, the impregnated support is dried and converted by calcination and, if appropriate, other known after-treatment methods (for example activation and subsequent surface passivation) into the ready-to-use absorption composition.

Impregnation processes for the deposition of silver and/or other substances on a support are known. In general, the support is impregnated with a solution of salts of silver and/or the other substances, with the volume of the solution being such that the solution is taken up virtually completely by the pore volume of the support (“incipient wetness” method). The concentration of the salts in the solution is set so that after impregnation and conversion of the impregnated support into the finished catalyst the components to be deposited are present in the desired concentration on the catalyst. The salts are selected so that they leave no residues which interfere in catalyst production or its later use. Nitrates or ammonium salts are usually employed. Impregnation of the support with an aqueous, if desired nitric acid solution of silver nitrate is preferred for producing the absorption composition of the invention.

The absorption composition of the invention is preferably produced by means of single-stage impregnation of the support by the incipient wetness method using a nitric acid solution of the nitrates of the metals to be deposited. The concentration of the nitric acid used is at least high enough for a clear solution to be present. In general, the pH of the solution is not more than 5, preferably not more than 2 and particularly preferably not more than 1.

After impregnation, the impregnated support is dried in a customary manner, generally at a temperature of at least 90° C., preferably at least 100° C. and particularly preferably at least 110° C., and generally not more 150° C., preferably not more than 140° C. and particularly preferably not more than 130° C. Drying is continued until water present in the impregnated support has been given off essentially completely, which is generally the case after a few hours. Usual drying times are in the range from one to 30 hours and are dependent on the drying temperature set; higher temperatures shorten the drying time. Drying can be accelerated further by use of reduced pressure.

After drying, the absorption composition is produced in a customary manner by calcination. This calcination serves essentially to convert the applied salts into the components to be deposited or precursors of such components and differs in this respect from the above-described calcination which serves to produce the support material and the support structure. If metal nitrates have been applied, this calcination essentially decomposes the nitrates into metals and/or metal oxides which remain in the catalyst and nitrous gases which are given off. Silver nitrate is decomposed into silver oxide.

The calcination temperature is generally at least 250° C., preferably at least 300° C. and particularly preferably at least 400° C., and generally not more than 600° C., preferably not more than 500° C. and particularly preferably not more than 470° C. The calcination time is generally from 0.5 to 20 hours, preferably from 0.5 to 10 hours and particularly preferably from 0.5 to 5 hours. The calcination is carried out in a customary furnace, for example in a rotary tube furnace, in a tunnel kiln or in a muffled furnace. The calcination can directly follow drying without intermediate cooling of the impregnated and dried support. At this temperature, silver salt is converted into elemental silver which on cooling in the presence of atmospheric oxygen is converted back into silver oxide.

After calcination, the absorption composition is in principle ready to use, If desired, it is activated in a known manner by prereduction and, if appropriate, once again passivated on the surface before it is used.

The absorption composition of the invention can be used in all known processes in which silver-comprising solids are used catalytically, adsorptively, absorptively or as reactants. It may be assumed that in the process of the invention, the absorption composition of the invention removes mercury by absorption of mercury to form amalgam, For the purposes of the present invention, adsorption is the attachment of an adsorbate to the surface of an adsorption composition (“adsorbent”), which can generally be reversed by desorption, The adsorbate can also be reacted chemically on the adsorbent; if the adsorbent remains essentially unchanged chemically as a result, the process is spoken of as catalysis, while if the adsorbate reacts chemically with the adsorbent, the process is referred to as absorption. In the case of pure adsorption as in the case of catalysis, the adsorbate or its reaction product is removed from the surface again by desorption, while in the case of absorption, chemical regeneration of the absorbent is usually necessary. As in the case of catalysis and in the case of absorption, the initial step is in each case an adsorption, and whether an adsorptive purification process ultimately (e.g. in the regeneration of the adsorption composition) ends in a catalytic step or an absorptive step or the process is purely adsorptive depends on the individual case. Adsorption compositions or absorption compositions are in everyday speech also often referred to as “catalysts” even if they do not actually act catalytically in their intended use.

In the process of the invention for removing impurities from streams, the stream to be freed of impurities is brought into contact with the absorption composition of the invention. Impurities which are preferably removed by means of the absorption composition of the invention are mercury, mercury-comprising compounds, arsenic and arsenic-comprising compounds. The process of the invention is very particularly useful for the removal of mercury and/or mercury-comprising compounds.

The streams which are to be freed of impurities can be any streams which can by engineering means be brought into contact with absorption composition of the invention in the manner required for absorption of impurities, i.e. are sufficiently fluid. In particular, these streams are liquids or gases. Typical industrially relevant streams from which impurities such as mercury, arsenic and/or compounds thereof, in particular mercury and/or compounds thereof, are removed by means of the process of the invention are, for example, nitrogen, helium, argon, crypton, xenon or hydrocarbons such as alkanes (methane, ethane, propane, butane, their mixtures, isomers and isomer mixtures, also natural gas) or alkenes (also referred to as “olefins”) such as ethene, propene, 1-butene, 2-butene, 1,3-butadiene and/or styrene, and also combustion offgases such as flue gas from power stations or water.

To carry out the process of the invention, the stream to be freed of impurities is passed over the bed of the shaped bodies of the absorption compositions of the invention in the absorber.

Temperature and pressure are, from a technical point of view, not very critical, if at all, for the process of the invention. Typical temperatures are in the range from at least −30°, preferably at least −10° C. and particularly preferably at least 0° C., to not more than 30° C., preferably not more than 100° C. and particularly preferably not more than 70° C. Typical pressures are in the range from at least 0.1 bar, preferably at least 0.5 bar and particularly preferably at least 1 bar, to not more than 150 bar, preferably not more than 100 bar and particularly preferably not more than 50 bar. Temperature and pressure are conveniently not influenced separately, but the process is carried out at the temperature and pressure of the stream to be treated, even if these deviate from the abovementioned typical ranges, which are not so much required by the process of the invention but simply correspond to typical industrial conditions of typical purification processes.

The important parameter which determines the degree of depletion is the contact time between stream and absorption composition. This contact time is determined by the flow rate of the stream and the volume of the bed of absorption composition. The volume flow of the stream to be purified is usually determined by the capacity of upstream or downstream plants. Furthermore, the absorption capacity of the absorption composition is limited, so that a particular amount of absorption composition can be utilized for the process of the invention only over a particular period of time before it has to be replaced or regenerated. Although this makes the use of a very large amount of absorption composition desirable, this is balanced by the costs which increase with the size of the absorber. The amount of absorption composition in the absorber is therefore selected in the particular case so that firstly the desired degree of depletion and secondly a tolerably short operating life of an absorber between two replacements or regenerations of the absorption composition are achieved. It is advantageous to provide at least two absorbers of which at least one can be supplied with the stream to be purified while the absorption composition in at least one other is replaced or regenerated. This is a routine optimization task for a person skilled in the art.

Depending on the absorber size selected, the maximum uptake capacity of the absorption composition present therein for impurities is reached sooner or later, so that it has to be replaced or regenerated.

The absorption composition of the invention can, if desired, be regenerated using any method known for silver-comprising absorption compositions for the removal of impurities such as mercury or arsenic. To regenerate the adsorption composition of the invention, it is usual firstly to shut off the stream to be purified and preferably pass it into a parallel absorber filled with fresh or regenerated absorption composition.

The absorption composition of the invention and the process of the invention make it possible to remove impurities from streams of substances in a simple and economical way. The streams which have been purified in this way can subsequently be used as intended. Advantages of the absorption composition of the invention are, for example, that the complicated reduction step from silver oxide to silver can be dispensed with and also that when using the absorption composition of the invention for removing mercury, arsenic and/or compounds thereof, no addition of hydrogen or similar auxiliaries is necessary.

### EXAMPLES

### Example 1

100 kg of a commercially available aluminum oxide support having a predominant proportion of theta-AL₂O₃ in the form of extrudates having a diameter of 3 mm were impregnated with a solution of 13.67 kg of silver nitrate in an amount of water corresponding to the pore volume of the support. The support was subsequently dried at 120° C. for 6 hours and calcined at 425° C. for 2 hours.

### Example 2

65 g of the absorption composition produced in Example 1 were exposed to a mercury-comprising nitrogen steam at room temperature in a tube reactor for 500 hours (corresponding to introduction of 0.06 mg/h of mercury into the reactor.) The absorption composition was then removed from the reactor in a total of 13 portions of 5 g each and analyzed for mercury. Mercury was detected only in the portion located at the gas inlet (corresponding to a content of 0.6000 g of mercury per 100 g of absorption composition); the mercury content of the remaining 12 portions was below the detection limit of 0.0001 g of Hg/100 g of absorption composition.

### Example 3

562 g of a commercially available aluminum oxide support having a predominant proportion of theta-Al₂O₃ in the form of extrudates having a diameter of 3 mm were impregnated with a solution of 75.7 g of silver nitrate in an amount of water corresponding to the pore volume of the support. The support was subsequently dried at 120° C. for 6 hours and calcined at 400° C. for 2 hours. The absorption composition produced in this way was subsequently treated with hydrogen at 170° C. until all of the silver had been reduced to metallic silver and the absorption composition was then cooled under inert gas.

### Example 4

Example 2 was repeated using the reduced absorption composition from Example 3 instead of that from Example 1. The mercury concentrations measured in the portions of absorption composition removed from the reactor are shown in the following table:

| | Portion No. | g of Hg/100 g of absorption composition |
|---|---|---|
| Gas inlet | 1 | 0.5400 |
| | 2 | 0.0005 |
| | 3 | 0.0003 |
| | 4 | 0.0004 |
| | 5 | 0.0022 |
| | 6 | below detection limit |
| | 7 | below detection limit |
| | 8 | below detection limit |
| | 9 | below detection limit |
| | 10 | below detection limit |
| | 11 | below detection limit |
| | 12 | 0.0002 |
| Gas outlet | 13 | 0.0020 |

Comparison of Example 4 with Example 2 shows that the unreduced absorption composition removes mercury from the gas steam even better than the reduced composition. The mercury is removed completely by the part of the unreduced composition which first comes into contact with the contaminated gas stream

### Example 5

An absorption composition as described in Example 1 was exposed to liquid propane contaminated with 100 ppm of arsane at room temperature in a tube reactor. The space velocity was 10 h⁻¹. Only after about 8 hours was arsane able to be measured in the offgas. Over the course of the next 16 hours, the arsane content of the offgas increased gradually to 80% of the arsane content in the feed to the reactor. The absorption composition accordingly removes arsane until it has reached a content of 0.7% by weight of arsenic.

1-10. (canceled)

11. An absorption composition comprising silver and aluminum oxide, wherein at least 50% by weight of the aluminum oxide is theta-aluminum oxide.

12. The absorption composition according to claim 11, wherein at least 60% by weight of the aluminum oxide is theta-aluminum oxide.

13. The absorption composition according to claim 12, wherein at least 70% by weight of the aluminum oxide is theta-aluminum oxide.

14. The absorption composition according to claim 13, wherein at least 80% by weight of the aluminum oxide is theta-aluminum oxide.

15. The absorption composition according to claim 11 whose BET surface area is in the range from 1 to 500 m²/g.

16. The absorption composition according to claim 14 whose BET surface area is in the range from 1 to 500 m²/g.

17. The absorption composition according to claim 11, wherein the silver is present as silver oxide.

18. The absorption composition according to claim 16, wherein the silver is present as silver oxide.

19. The absorption composition according to claim 11, wherein the silver oxide content of the absorption composition is in the range from 0.01 to 30% by weight, based on the total composition.

20. The absorption composition according to claim 18, wherein the silver oxide content of the absorption composition is in the range from 0.01 to 30% by weight, based on the total composition.

21. A process for removing impurities from a stream of substances which comprises bringing the stream into contact with the absorption composition as claimed in claim 11.

22. The process according to claim 21, wherein mercury, arsenic or a mixture thereof is removed from the stream of substances.

23. The process according to claim 21, wherein the stream is a hydrocarbon stream.

24. A process for removing impurities from a stream of substances which comprises bringing the stream into contact with the absorption composition as claimed in claim 20.

25. The process according to claim 24, wherein mercury, arsenic or a mixture thereof is removed from the stream of substances.

26. The process according to claim 25, wherein the stream is a hydrocarbon stream.
